(19) United States
(12) Patent Application Publication
(10) Pub. No.: US 2026/0290264 A1
(43) Pub. Date: Sep. 24, 2026

(54) COLOR COMPENSATION METHOD OF DISPLAY DEVICE AND DISPLAY DEVICE

(71) Applicant: MEDIATEK INC., Hsinchu City (TW)

(72) Inventors: Kuo-Chen HUANG, Hsinchu City (TW); Wei-Ting HUANG, Hsinchu City (TW); Shih-Heng TSAI, Hsinchu City (TW); Chun-Kang PENG, Hsinchu City (TW); Ruei-Jyun CHANG, Hsinchu City (TW); Kai-Chen WANG, Hsinchu City (TW); Wen-Huei LO, Hsinchu City (TW)

(21) Appl. No.: 19/570,691

(22) Filed: Mar. 18, 2026

Related U.S. Application Data
(60) Provisional application No. 63/776,355, filed on Mar. 24, 2025.

(51) Int. Cl. G09G 3/34

(52) U.S. Cl. CPC G09G 3/3413; G09G 2320/0242; G09G 2320/0666

(57) ABSTRACT

A color compensation method of a display device is provided. The display device includes a display panel and a backlight module, the display panel has a plurality of pixels, and the backlight module includes a plurality of light-emitting elements. The method includes obtaining operational information for each of the light-emitting elements. The method includes retrieving a light profile associated with the operational information, wherein the light profile includes color distribution information corresponding to the respective light-emitting element, and the color distribution information is represented by a plurality of color channels. The method includes determining a resultant backlight color value for each pixel based on light intensity distributions of the light-emitting elements within each of the color channels derived from the light profile. The method includes adjusting a pixel value of at least one of the plurality of pixels based on the resultant backlight color value corresponding to said pixel.

### CROSS REFERENCE TO RELATED APPLICATIONS

This application claims the benefit of U.S. Provisional Application No. 63/776,355, entitled “Color Variations Compensation”, filed on Mar. 24, 2025, the entirety of which is incorporated by reference herein.

### BACKGROUND OF THE INVENTION

### Field of the Invention

The present disclosure generally relates to the field of display. More specifically, aspects of the present disclosure relate to a color compensation method of a display device, and a display device.

### Description of the Related Art

Unless otherwise indicated herein, approaches described in this section are not prior art to the claims listed below and are not admitted as prior art by inclusion in this section.

In modern liquid-crystal display (LCD) technology, the visual result perceived by the viewer is determined by the interaction between the light emitted from a backlight and the proportion of light allowed to pass through pixel filters. To enhance contrast and achieve deeper blacks and brighter whites, local dimming (LD) techniques are employed to individually adjust the brightness of specific zones within a backlight unit. By modulating these independent zones, the display can achieve a more dynamic and vivid image.

However, a significant technical challenge in actual operation is that the light emitted by “white” light-emitting elements is not purely white. The chromaticity of these elements is not static; it changes based on various operational factors, primarily the driving current and the accumulated usage time.

As illustrated in FIG. 1A, the spectral power distribution of a light-emitting element varies significantly with the driving current. Under low current conditions, the energy levels of the Red (R), Green (G), and Blue (B) channels are relatively balanced, often resulting in a cooler, blueish-white light. Conversely, under high current conditions, the energy of the R and G channels increases more prominently than the B channel. This imbalance causes the light to shift toward a warmer, yellowish-white hue.

Furthermore, the color distribution is non-uniform across the physical space of a single light-emitting element. FIG. 1B illustrates how the energy levels of the R, G, and B channels change relative to the distance from the light-emitting center. As shown in FIG. 1B, in the region near the light-emitting center (e.g., at position 0), the energy levels of the R and G channels are higher than that of the B channel, which causes the center area to appear yellowish. As the distance from the center increases, the energy proportions shift, leading to peripheral regions that appear more blueish.

Conventional local dimming methods focus almost exclusively on describing the luminance (brightness) of the light-emitting elements. However, in applications requiring high color fidelity, brightness information alone is insufficient to describe the actual color output. When the device fails to account for these color shifts induced by current, spatial positioning, or usage time, the display cannot ensure accurate and consistent color representation across all operating conditions.

Therefore, there is an urgent need for an improved color compensation method of a display device, as well as a display device that can address the aforementioned technical challenges and ensure precise and consistent color performance across various operating conditions.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

In an exemplary embodiment, a color compensation method of a display device is provided. The display device comprises a display panel and a backlight module, the display panel has a plurality of pixels, and the backlight module comprises a plurality of light-emitting elements. The method includes obtaining operational information for each of the light-emitting elements. The method further includes retrieving a light profile associated with the operational information, wherein the light profile comprises color distribution information corresponding to the respective light-emitting element, and the color distribution information is represented by a plurality of color channels. The method further includes determining a resultant backlight color value for each pixel based on light intensity distributions of the light-emitting elements within each of the color channels derived from the light profile. The method further includes adjusting a pixel value of at least one of the plurality of pixels based on the resultant backlight color value corresponding to said pixel.

In some embodiments, the operational information comprises at least one of: a driving current, temperature, a usage time of the respective light-emitting elements, and a distance from a center of each of the light-emitting elements.

In some embodiments, the adjusting of the pixel value based on the resultant backlight color value further comprises transforming the resultant backlight color value into local gamut information corresponding to each pixel, and compensating pixel values of an input image according to the local gamut information.

In some embodiments, the compensating of the pixel values of the input image according to the local gamut information further comprises: performing a gamut mapping to map the pixel values of the input image to a target color gamut determined by the local gamut information.

In some embodiments, the resultant backlight color value comprises a summed intensity of each color channel at a location corresponding to each pixel.

In some embodiments, the color distribution information comprises values associated with at least one color channel in a color representation space.

In some embodiments, the light profile further comprises at least one of: spectral distribution information, spatial luminance distribution information, spatial energy distribution information, or a spatial profile describing intensity as a function of distance from the respective light-emitting element.

In some embodiments, the light-emitting element comprises a monochromatic light-emitting diode (LED) or a multi-color LED module.

In an exemplary embodiment, a display device is provided. The display device comprises a display panel and a backlight module, wherein the display device comprises a display panel and a backlight module, the display panel has a plurality of pixels, and the backlight module comprises a plurality of light-emitting elements. The display device further comprises a memory and at least one processor coupled to the memory. The at least one processor performs operations comprising: obtaining operational information for each of the light-emitting elements; retrieving a light profile associated with the operational information, wherein the light profile comprises color distribution information corresponding to the respective light-emitting element, and the color distribution information is represented by a plurality of color channels; determining a resultant backlight color value for each pixel based on light intensity distributions of the light-emitting elements within each of the color channels derived from the light profile; and adjusting a pixel value of at least one of the plurality of pixels based on the resultant backlight color value corresponding to said pixel.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale, as some components may be shown out of proportion to their size in actual implementation in order to clearly illustrate the concept of the present disclosure.

FIG. 1A illustrates how the spectral power distribution of the light-emitting element varies significantly with the driving current.

FIG. 1B illustrates how the energy levels of the R, G, and B channels change relative to the distance from the light-emitting center.

FIG. 2A illustrates a traditional method of recording brightness information using only a single channel.

FIG. 2B is a schematic diagram of a light profile, including a plurality of spatial energy distribution curves corresponding to different color components, in accordance with an implementation of the present disclosure.

FIG. 3 is a flowchart illustrating a color compensation method of a display device in accordance with an implementation of the present disclosure.

FIG. 4 illustrates a schematic diagram of the color compensation concept applied to a white LED panel in accordance with an implementation of the present disclosure.

FIGS. 5A~5C illustrate how light profiles for different driving currents are recorded and combined in accordance with an implementation of the present disclosure.

FIGS. 6A~6C illustrate the implementation of compensation applied to multi-color light-emitting elements in accordance with an implementation of the present disclosure.

FIGS. 7A~7B illustrate the effects achieved by applying the color compensation method in accordance with an implementation of the present disclosure.

FIG. 8 is a schematic structural diagram of a display device in accordance with the present disclosure.

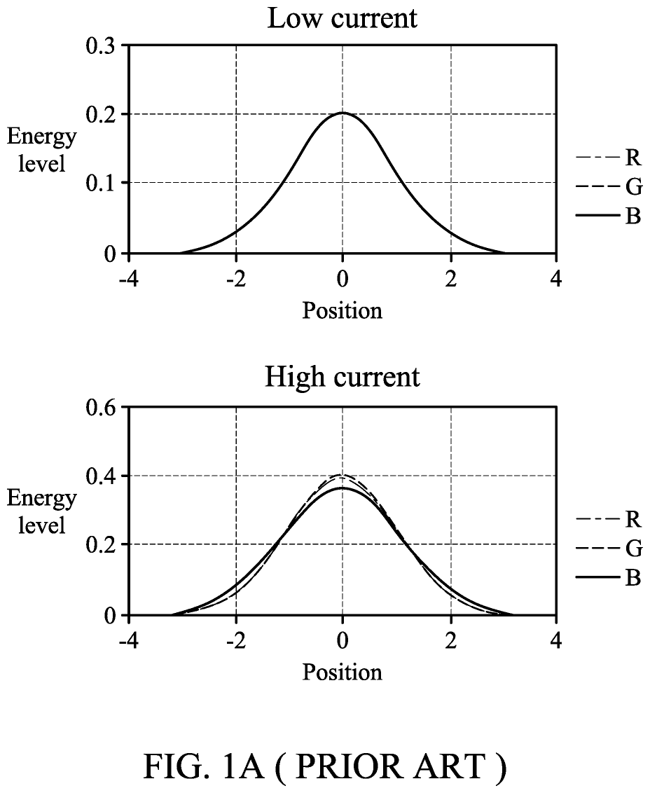

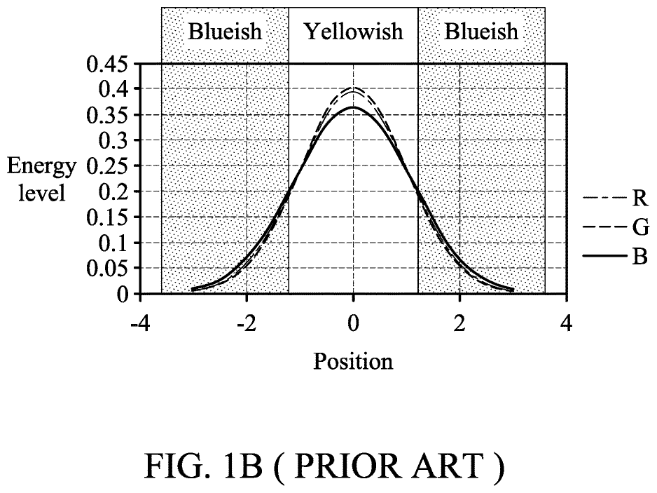

### DETAILED DESCRIPTION OF THE INVENTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not shown) by the same numerals in the example figures. However, the features in different implementations may differ in other respects, and thus shall not be narrowly confined to what is shown in the figures.

The description uses the phrases “in one implementation” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. The expression “at least one of A, B, and C” or “at least one of the following: A, B, and C” means “only A, or only B, or only C, or any combination of A, B, and C.”

The solution proposed in the present disclosure utilizes multiple channels to describe the light profile of a light-emitting element, thereby addressing color accuracy issues caused by recording only luminance information in traditional techniques.

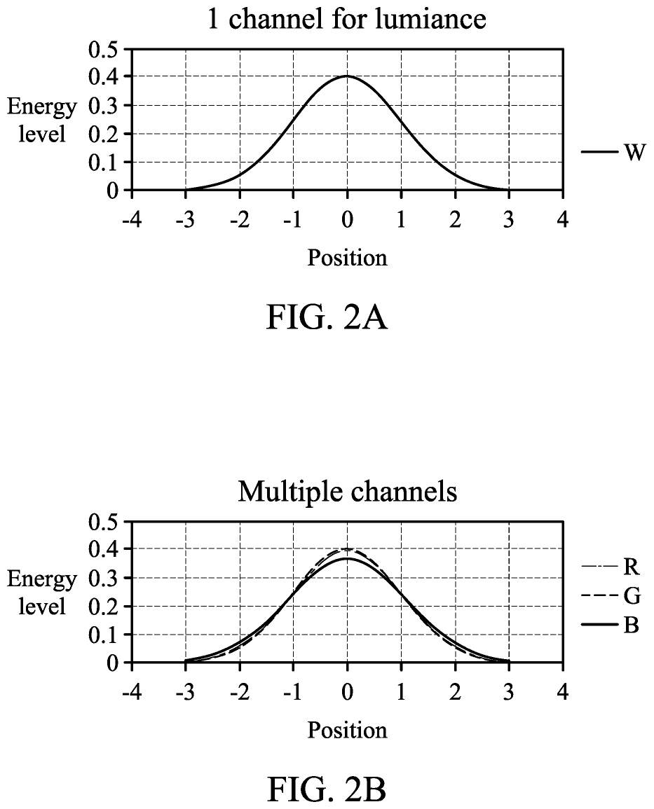

Traditional methods typically use only a single channel to record luminance information (e.g., 1 channel for luminance). As shown in the schematic diagram of the traditional method in FIG. 2A, the light profile only contains a single luminance curve (W), which fails to reflect the actual color variations of the light-emitting element. In contrast, the method proposed in the present disclosure utilizes multiple channels to describe the light profile, thereby embedding critical color information within the light profile.

The multi-channel light profile is not limited to RGB three channels and may be expanded to more channels according to system and device requirements to record richer spectral data. As shown in FIG. 2B, the light profile includes a plurality of spatial energy distribution curves corresponding to different color components, such as red light (R), green light (G), and blue light (B). Through this description method that embeds color information, the system or the device may obtain the actual emitted color of the light-emitting element under various operating conditions while simultaneously acquiring luminance information. The specific implementation of the color compensation in the present disclosure will be explained in detail below, including technical details on how to utilize the multi-channel light profile in combination with the backlight gamut information of each pixel to perform gamut mapping, thereby achieving precise color representation.

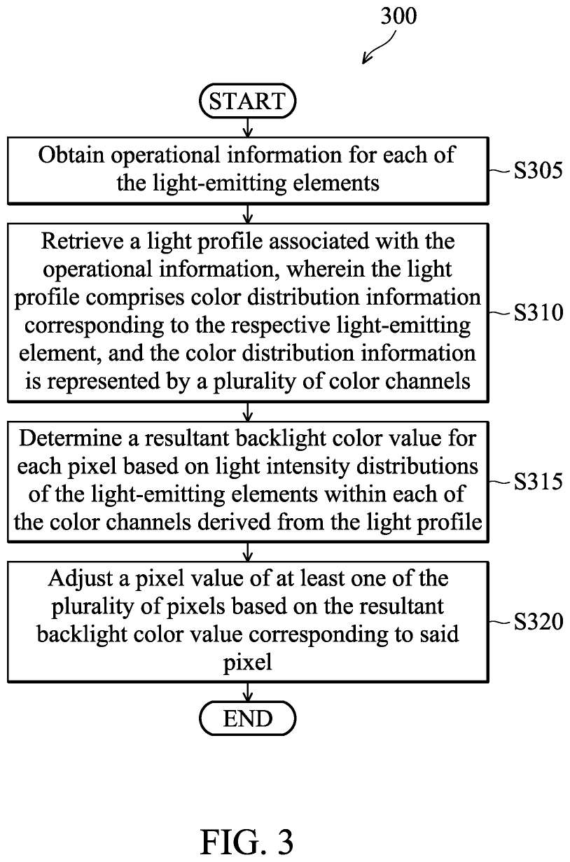

FIG. 3 is a flowchart illustrating a color compensation method 300 of a display device in accordance with an implementation of the present disclosure. In the color compensation method 300, the display device includes a display panel and a backlight module, wherein the display panel has a plurality of pixels, and the backlight module comprises a plurality of light-emitting elements. The color compensation method 300 may be implemented by a processor of a display device or any suitable device. For the convenience of illustration and not by way of limitation, the processor of the display device is taken as an example below to describe the color compensation method 300. It should be noted that, prior to the start of the color compensation method 300, it is assumed that the light profile has already been established.

Regarding the specific construction of the light profile in the present disclosure, it is measured and established before the device leaves the factory (e.g., during factory calibration) and pre-stored in the display device. Specifically, it is first necessary to measure the color change rules of a LED under the influence of various operational factors through corresponding sensors. These factors include driving current, spatial distance, temperature, and accumulated usage time, thereby establishing a detailed mapping between different factor levels and the corresponding color output for each LED. Specifically, during the measurement stage before the device leaves the factory, the system measures and analyzes the direction of color shift based on usage time, and analyzes color change trends under low current and high current conditions. For instance, it is observed that low current tends toward cool white light while high current tends toward warm white light. Furthermore, it is also necessary to analyze the rules of color shift relative to spatial position, such as the characteristic of tending toward warmer yellowish light near the optical center, while tending toward cooler blueish light in peripheral regions.

In terms of measurement methods and modeling, luminance meters or imaging-based measurement methods (such as photography) may be employed during the pre-factory stage to obtain the energy and shape distributed by the LED. In one embodiment, a camera may be utilized to photograph the LED, thereby acquiring the shape and energy information within the image. Since an image format natively possesses multiple channels (e.g., R, G, B) for recording data, it effectively captures multi-dimensional color data. Based on these methods, the system accurately models the variations in shape and color produced by the LED under different circumstances and constructs them into a light profile for subsequent use.

After obtaining the measurement information, the system converts and records it into a multi-channel light profile to replace the traditional method of recording only luminance, thereby capturing comprehensive color information. Such a profile includes, but is not limited to, R, G, and B channels, embedding color data within the profile at different brightness levels. The light profile described herein is flexible and may include shape information, spectral distribution, luminance distribution, color distribution, or energy distribution. Overall, the light profile at least includes color distribution information and may further comprise values associated with at least one color channel in a color representation space, which may include, but is not limited to, RGB, hue, saturation, brightness, CIE XYZ, CIELAB, YUV, or other mathematical color models used for characterizing color information.

In step S305, the processor of the device obtains operational information for each of the light-emitting elements. In some implementations, the operational information comprises at least one of the following: a driving current, temperature, a usage time of each of the light-emitting elements, and a distance from a center of each of the light-emitting elements. The step of obtaining operational information for each of the light-emitting elements may encompass direct acquisition of individual operational information for each light-emitting element, or indirect derivation thereof through measurement of zone or region parameters and subsequent calculation, modeling, or estimation of the operational information for each individual element. The present invention is not limited to a particular method of acquisition or derivation, so long as operational information for each element can be obtained or inferred for use in subsequent compensation steps. In some implementations, the light-emitting element is not limited to a white light-emitting diode (LED), and may include a monochromatic LED, or a multi-color LED module (e.g., an Red-Green-Blue (RGB) LED, Red-Green-Blue-White (RGBW) LED, or Blue-Yellow (BY) LED).

Then, in step S310, the processor retrieves a light profile corresponding to the operational information, wherein the light profile comprises color distribution information of the light-emitting element, and the color distribution information is represented by a plurality of color channels. For example, the plurality of color channels may include, but are not limited to, RGB channels (red, green, blue); HSB or HSV (hue, saturation, brightness/value); CIE XYZ; CIE Lab (L*, a*, b*); YUV; YCbCr; or any other color models or spaces suitable for image processing, display, or color management applications. The plurality of color channels are not restricted to the traditional RGB three-channel format. However, the light profile comprises at least two color channels to effectively capture and represent the color characteristics of the light-emitting element.

Next, in step S315, the processor determines a resultant backlight color value for each pixel based on light intensity distributions of the light-emitting elements within each of the color channels derived from the light profile. Specifically, since the light profile is represented by multiple channels, the accumulation process is performed for each individual color channel. For example, in an embodiment utilizing RGB channels, the accumulation is executed three times (i.e., once for each channel) to aggregate the multi-channel information, such that each pixel ultimately obtains a set of values (e.g., an RGB value) representing the specific color of the backlight received by that pixel.

In one embodiment, the accumulation process may be a simple summation (i.e., direct addition) of the light intensity contributions in each channel from all relevant light-emitting elements. In other implementations, the accumulation process may involve a weighted summation, wherein the contribution of each light-emitting element to each pixel in a given color channel is multiplied by a corresponding weighting factor. Such weighting factors may be determined according to the spatial relationship between the pixel and each light-emitting element (for example, based on distance, angular distribution, optical path loss, or other physical parameters), or may be adaptively derived from empirical measurements, calibration data, or algorithmic modeling. In further embodiments, the accumulation process may comprise nonlinear weighted combinations, wherein the contributions are aggregated using nonlinear functions such as exponential, logarithmic, sigmoid, or polynomial mappings to better reflect complex optical interactions. Additionally, the accumulation process may employ lookup tables (LUTs) that store pre-determined aggregation results based on measured or simulated profiles. These advanced techniques allow the system to accommodate and optimize for a wide variety of display architectures, backlight characteristics, and compensation scenarios, ensuring accurate determination of the resultant backlight color value for each pixel.

In a practical application, such as a display comprising a plurality of light-emitting elements (for instance, four LEDs), each light-emitting element contributes to the intensity received by every pixel within the display panel. Even though a particular light-emitting element is located far from a specific pixel, it still exerts a contributing influence, though the intensity of such a contribution may be diminished. Therefore, the processor performs a fusion operation by accumulating the light profiles of these light-emitting elements. During this fusion process, the specific light profile utilized for each light-emitting element is dynamically determined and selected based on its individually controlled brightness, driving current, and accumulated usage time. By combining these influences across all channels, the resultant backlight color value corresponding to each pixel on the screen may be accurately determined.

In step S320, the processor adjusts a pixel value of at least one of the plurality of pixels based on the resultant backlight color value corresponding to said pixel. Specifically, the adjusting of the pixel value based on the resultant backlight color value further comprises transforming the resultant backlight color value into local gamut information corresponding to each pixel and compensating pixel values of an input image according to the local gamut information.

Regarding the transformation, the resultant backlight color value (e.g., a set of RGB energy values R_{bl}, G_{bl}, B_{bl}) obtained from step S315 is used to determine the local gamut information (also referred to as the target color gamut) for each pixel. In a preferred embodiment, the target color gamut matrix [pixelGamut] is calculated using the following formula:

$$[ pixelGamut ] = {R}_{b l} \times [ Mat\_R ] + {G}_{b l} \times [ Mat\_G ] + {B}_{b l} \times [ Mat\_B ]$$

wherein, R_{bl}, G_{bl}, B_{bl} represent the resultant backlight color values (energy levels) received by a specific pixel in the Red, Green, and Blue channels, respectively. [Mat_R], [Mat_G], and [Mat_B] represent the base primary matrices of the light-emitting element. This per-pixel gamut reflects the actual color space the pixel may achieve after accounting for backlight color shifts induced by current, spatial distance, or usage duration.

Furthermore, the compensating of the pixel values further comprises performing a gamut mapping to map the pixel values of the input image to a target color gamut determined by the local gamut information. This step converts the input image data from a source gamut ([Source_{gamut}], such as the maximum displayable gamut of the display panel) into the target color gamut ([pixelGamut]) of each pixel. The specific compensation calculation is performed as shown in the following formula:

$$[ \begin{matrix}outR \\ outG \\ outB\end{matrix} ] = {[ pixelGamut ]}^{- 1} * [ {Source}_{gamut} ] * Degamma ( [ \begin{matrix}s r c R \\ s r c G \\ s r c B\end{matrix} ] )$$

Through this three-dimensional matrix operation, the system or the device may accurately adjust the RGB gain values for each pixel. Unlike traditional methods that only perform one-dimensional compensation on luminance, the color compensation method of the present disclosure ensures that the final visual result perceived by a viewer maintains accurate and consistent color representation, even under circumstances where the backlight color shifts, such as becoming yellowish at the center or blueish at the periphery.

In another embodiment, the adjustment of a pixel value of at least one of the plurality of pixels based on the resultant backlight color value corresponding to said pixel may be performed without employing gamut mapping matrix operations. In such implementations, the processor may apply compensation using a three-dimensional look-up table (3D LUT) or, in a simplified approach, a one-dimensional look-up table (1D LUT). Specifically, the resultant backlight color value for each pixel is referenced by the LUT to provide compensation values or adjustment parameters. The 3D LUT enables complex color transformations based on multi-channel input, efficiently accommodating local gamut variations. On the other hand, the 1D LUT provides a more basic compensation mechanism by adjusting each color channel independently. These alternatives offer flexibility in implementation and may reduce computational complexity when matrix-based gamut mapping is not employed.

In some implementations, the resultant backlight color value comprises a summed intensity each color channel at a location corresponding to each pixel. In another embodiment, the summed intensity may represent, but is not limited to, a luminance value, a grayscale level, a radiant flux, or tri-stimulus values associated with each color channel at a given spatial coordinate. In yet another embodiment, the summed intensity includes a set of color component values, such as a red component value, a green component value, and a blue component value.

In some implementations, the color distribution information comprises values associated with at least one color channel in a color representation space. The color representation space may include, but is not limited to, RGB channels (red, green, blue); HSB or HSV (hue, saturation, brightness/value); CIE XYZ; CIE Lab (L*, a*, b*); YUV; YCbCr; or any other color models or spaces suitable for image processing, display, or color management applications. The present invention is not limited to any particular color representation system, and may utilize any space or model wherein color distribution can be defined or computed in one or more channels for each light-emitting element or pixel.

In some implementations, the light profile further comprises at least one of the following: spectral distribution information, spatial luminance distribution information, and spatial energy distribution information, or a spatial profile describing intensity as a function of distance from the respective light-emitting element.

It should be understood that the color channels employed in the present disclosure are not limited to the Red (R), Green (G), and Blue (B) color space. In other embodiments, color distribution information may also be mapped to other color spaces through mathematical transformations for computation, such as the hue, saturation, and brightness (HSB) color space, or the hue, saturation, and value (HSV) color space, CIE XYZ, CIE Lab (L*, a*, b*), YUV, YCbCr, or any other color models or spaces suitable for image processing, display, or color management applications, without being limited thereto. Through such color space transformations, the display device is enabled to obtain corresponding parameter information, such as hue, saturation, and brightness/luminance, thereby facilitating more precise image compensation and color correction operations based on various display requirements.

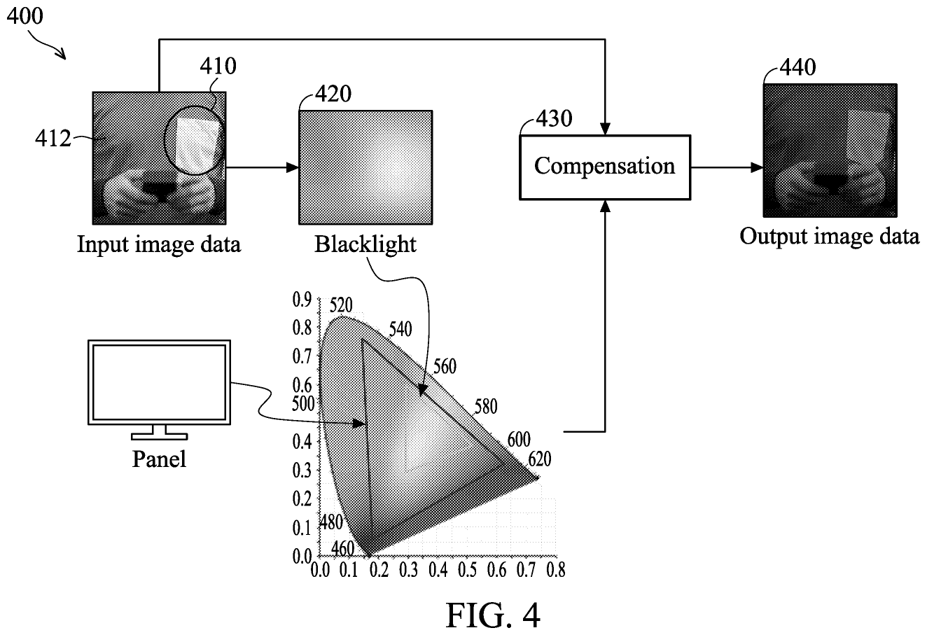

FIG. 4 illustrates a schematic diagram 400 of the color compensation concept applied to a white LED panel in accordance with an implementation of the present disclosure. FIG. 4 specifically uses white light-emitting elements (such as white LEDs) as an example, aiming to emphasize that the color compensation method of the present disclosure possesses critical significance for color compensation even in traditional white light systems typically regarded as having only luminance.

When the input image data contains regions with different brightness requirements (e.g., the white label 410 and the darker background 412 in the scene), the device drives the white LEDs in corresponding regions with currents of varying magnitudes. However, the light emitted by white LEDs is not ideally pure white. Its chromaticity changes slightly with variations in the driving current. Therefore, as shown in the backlight 420 of FIG. 4, the backlight plane actually generated behind the panel is not a uniform grayscale color distribution but is filled with regions of minute color variations caused by current differences (such as the reddish or greenish regions schematically shown in FIG. 4).

Next, the compensation method 430 in FIG. 4 processes the image data. Finally, when the compensated output image data 440 is displayed on the panel, it effectively corrects the color distortion caused by the non-pure white backlight, ensuring that the final visual result perceived by the viewer possesses precise and consistent color representation, as shown by the output image data 440 with corrected, more accurate colors in FIG. 4.

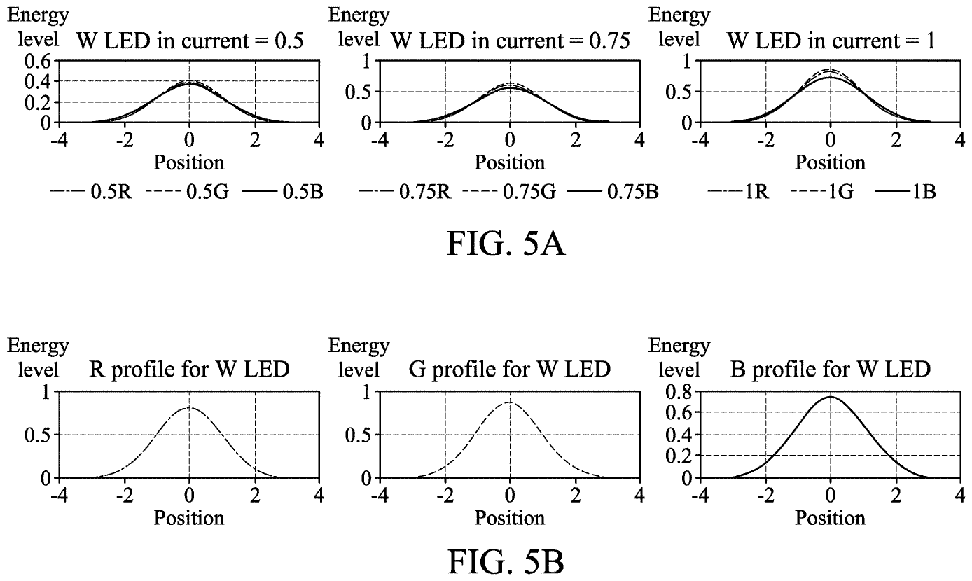

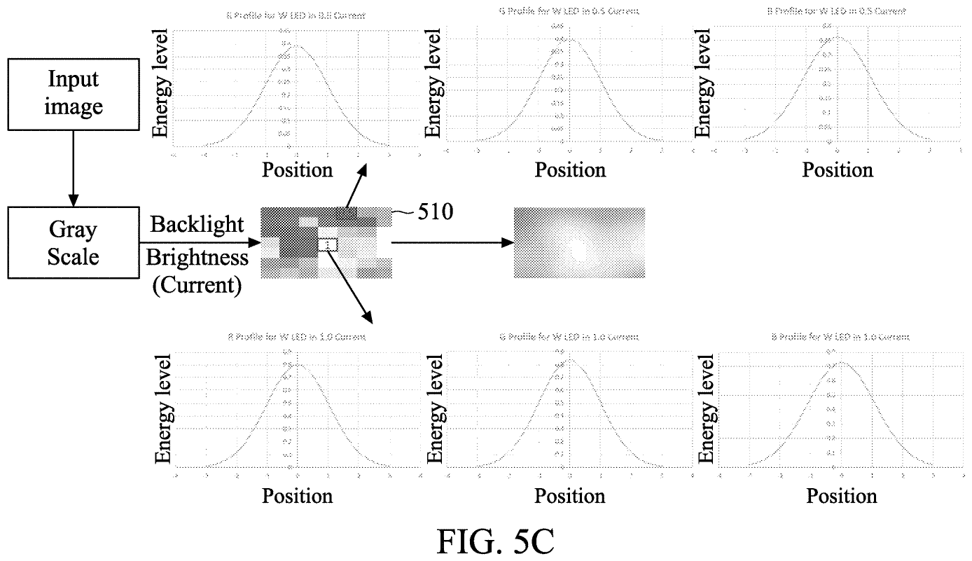

FIGS. 5A~5C illustrate how light profiles for different driving currents are recorded and combined in accordance with an implementation of the present disclosure.

As shown in FIGS. 5A~5B, a light-emitting element possesses specific spatial light intensity distributions at various current levels (e.g., 0.5, 0.75, and 1.0). When recording these distributions, a multi-channel approach must be utilized to separate and record different color components (e.g., R, G, B). For a white light-emitting element, the variation in driving current is the primary factor affecting the brightness of the bulb. Specifically, a higher current is applied when higher brightness is required (e.g., brightness of 1.0), whereas a lower current is applied when lower brightness is required (e.g., brightness of 0.5).

Next, in FIG. 5C, each grid cell in image 510 represents a light-emitting element that emits light at a different current according to image requirements. The device must retrieve the corresponding light profile based on the specific current or brightness controlled for the light-emitting element in each grid cell. For example, for a light-emitting element whose brightness is controlled at a 0.5 current, the corresponding 0.5-current light profile is selected; for a light-emitting element controlled at a 1.0 current, the corresponding 1.0-current light profile is selected. In this embodiment, brightness adjustment is achieved by controlling different currents, ensuring that color distribution characteristics under different brightness levels are accurately reflected when combining the light intensity distributions.

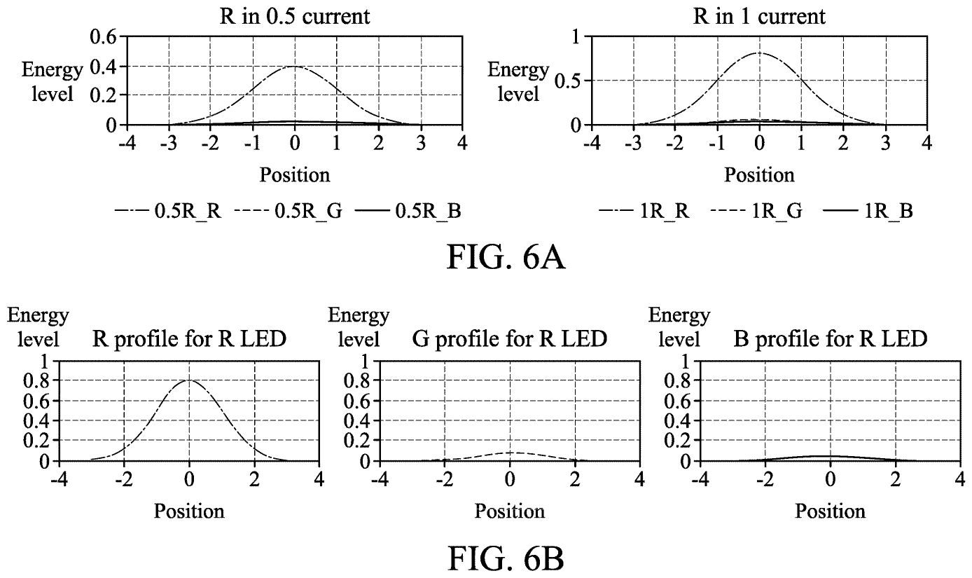

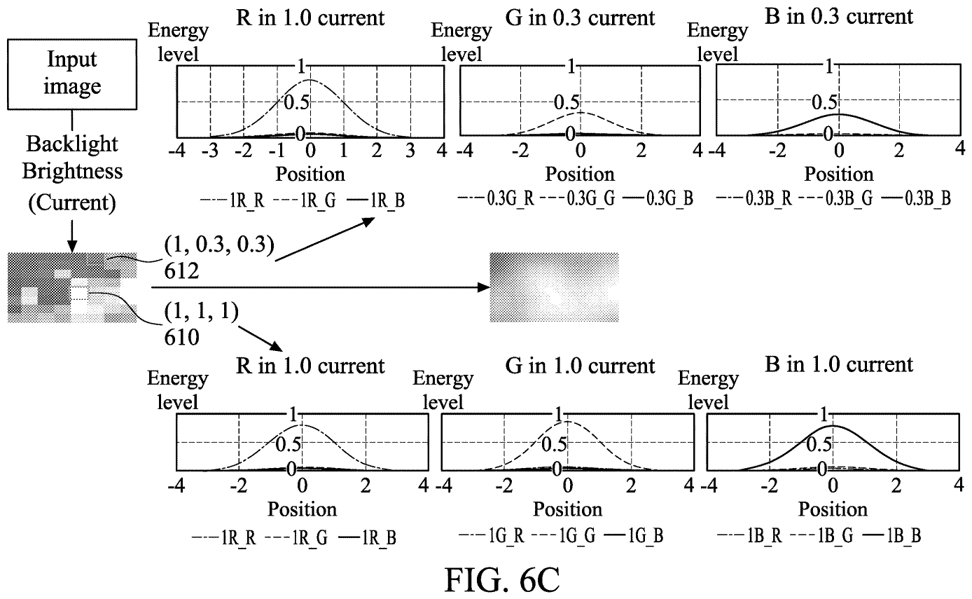

FIGS. 6A~6C illustrate the implementation of compensation applied to multi-color light-emitting elements (e.g., a combination of Red (R), Green (G), and Blue (B) LEDs) in accordance with an implementation of the present disclosure. Unlike pure light sources in FIGS. 5A~5C, individual color lights in a multi-color system are often not perfectly pure.

As shown in FIGS. 6A~6B, taking the red light (R LED) as an example, the light emitted by this element may not be pure red but may contain subtle blue or green components. Therefore, when constructing the light profile, the variations of the R, G, and B channel distributions for that specific color element (e.g., R LED) under different current levels are recorded. Similar recording processes are performed for the green (G LED) and blue (B LED) elements.

FIG. 6C further illustrates the lookup method under multi-color distribution. When the device intends to display different color regions, the required RGB brightness ratio for each region varies accordingly. For instance, when the current for a white region 610 is (1, 1, 1), the processor retrieves the light profiles for the R, G, and B LEDs at a current level of 1. In another case, when the current for a red region 612 is (1, 0.3, 0.3), the processor retrieves the light profile for the R LED at a current level of 1, and retrieves the light profiles for the G and B LEDs at a current level of 0.3, respectively.

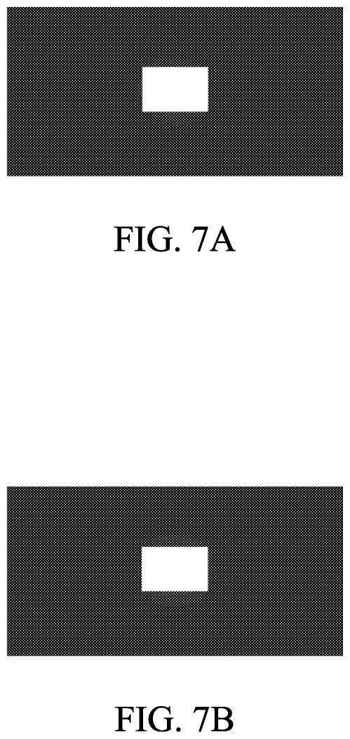

FIGS. 7A~7B illustrate the effects achieved by applying the color compensation method in accordance with an implementation of the present disclosure. Taking the white light emitted by the backlight of a display as an example, when the white light generated by an LED exhibits a color shift (e.g., a yellowish tint), it may cause the viewer to perceive a yellowish image, as shown in FIG. 7A. Since the color compensation method provided in the present disclosure has pre-considered the color characteristics of the LED, such a yellowish effect may be effectively eliminated after compensation processing, thereby restoring the display image to correct colors, as shown in FIG. 7B.

Accordingly, the color compensation method of the display device the present disclosure utilizes light profiles comprising a plurality of dimensions to characterize the color attributes of a light source. When the processor performs operations based on various pieces of operational information, it separately retrieves light profiles corresponding to red (R), green (G), and blue (B) LEDs to accurately describe the color distribution information under the respective operating conditions. By pre-considering the color characteristics of the light source (such as inherent yellowish or pinkish shifts of the backlight source), the compensation process of the present disclosure effectively neutralizes interference from light source color deviations, thereby ensuring that the display device achieves precise and consistent color reproduction effects across various operating conditions.

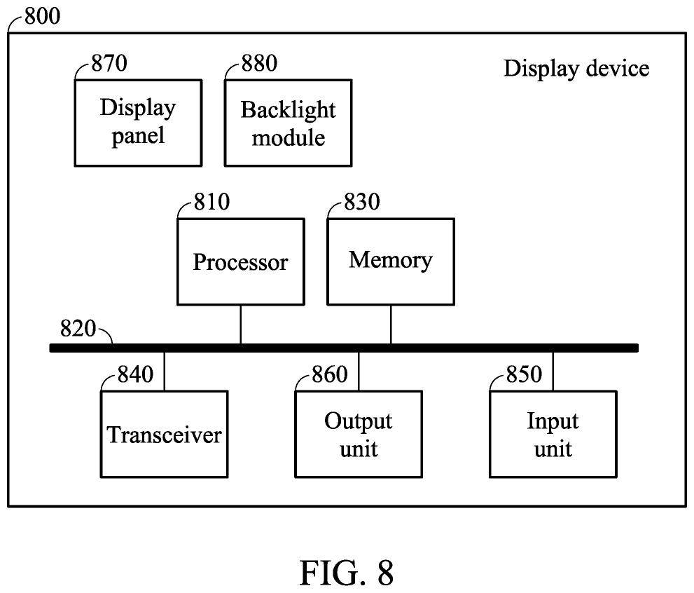

The present disclosure provides in an alternative embodiment a display device, as shown in FIG. 8, the display device 800 shown in FIG. 8 including: a processor 810 and a memory 830. The processor 810 and the memory 830 are electrically coupled, such as via bus 820, among other things.

The display device 800 in which the present invention may be implemented can be any type of display technology or configuration and is not limited to a specific display structure. For example, the display device 800 may include but is not limited to: a liquid crystal display (LCD) having a multi-color LED backlight module, such as RGB, RGBW, RGGB, or other multi-wavelength LED arrangements; a liquid crystal display (LCD) with a monochromatic or white LED backlight module including edge-lit, direct-lit, or diffuser-type structures; a mini-LED backlight LCD panel with either mono-color or multi-color local dimming zones; a field sequential color display (FSC) or field sequential display (FSD), wherein color display is achieved by sequentially illuminating the panel with different colored light fields; a quantum dot enhanced display (QLED) utilizing quantum dots to convert LED emissions into wide-gamut color backlight for the panel; an electrophoretic, electroluminescent, or electrochromic display incorporating controlled backlight or emissive elements; a projection display system with dynamically compensated illumination profiles such as those using a color wheel or RGB LED arrays; or flexible, transparent, wearable, automotive, or head-up display panels, or AR/VR displays that employ pixel-wise or area-wise controllable backlight, emissive arrays, or sequential color illumination. It will be appreciated that the present invention is applicable to any display device in which pixel values are compensated according to the color characteristics of light-emitting or backlight modules whose operational parameters can be measured or adjusted, regardless of the physical arrangement, emission mechanism, or display driving scheme.

The processor 810 may be a CPU (Central Processing Unit), general purpose Processor, DSP (Digital Signal Processor), ASIC (Application Specific Integrated Circuit), FPGA (Field Programmable Gate Array), or other Programmable logic device, transistor logic, hardware component, or any combination thereof. Which may implement or execute the various illustrative logical blocks, modules, and circuits described in connection with the disclosure. The processor 810 may also be a combination of computing functions, e.g., including one or more microprocessors, DSPs and microprocessors, and the like.

The bus 820 may include a path that conveys information between the aforementioned components. The bus 820 may be a PCI (Peripheral Component Interconnect) bus, an EISA (Extended Industry Standard Architecture) bus, or the like. The bus 820 may be divided into an address bus, a data bus, a control bus, and so on. For ease of illustration, only one thick line is shown in FIG. 8, but that does not indicate only one bus or one type of bus.

The memory 830 may be a ROM (Read-Only Memory) or other type of static storage device that can store static information and instructions, a RAM (random access Memory) or other type of dynamic storage device that can store information and instructions, an EEPROM (Electrically Erasable Programmable Read-Only Memory), a CD-ROM (Compact disk Read-Only Memory) or other optical disk storage, optical disk storage (including Compact disk, laser disk, optical disk, digital versatile disk, Blu-ray disk, etc.), a magnetic disk storage medium or other magnetic storage device, or any other medium that can be used to carry or store desired program code in the form of instructions or data structures and that can be accessed by a computer, but is not limited to such.

Optionally, the display device 800 may also include a transceiver 840. The transceiver 840 may be used for reception and transmission of signals. The transceiver 840 may allow the display device 800 to communicate with other devices wirelessly or by wire to exchange data. It should be noted that the transceiver 840 is not limited to one in practice.

Optionally, the display device 800 may further include an input unit 850. The input unit 850 may be used to receive input numeric, character, image, and/or sound information, or to generate key signal inputs related to user settings and function control of the display device 800. The input unit 850 may include, but is not limited to, one or more of a touch screen, a physical keyboard, function keys (such as volume control keys, switch keys, etc.), a trackball, a mouse, a joystick, a camera, a microphone, and the like.

Optionally, the display device 800 may further include an output unit 860. The output unit 860 may be used to output or show information processed by processor 810. The output unit 860 may include, but is not limited to, one or more of a display device, a speaker, a vibration device, and the like.

The display device 800 may further include a display panel 870 and a backlight module 880, the display panel 870 being divided into a plurality of display subareas, and the backlight module 880 including a plurality of backlight subareas, the display subareas and the backlight subareas being in one-to-one correspondence.

While FIG. 8 illustrates a display device 800 having various means, it is to be understood that not all illustrated means are required to be implemented or provided. More or fewer devices may be alternatively implemented or provided.

Optionally, the memory 830 is used to store at least one program for performing the disclosed aspects and is controlled in execution by the processor 810. The processor 810 is configured to execute at least one program stored in the memory 830 to implement any one of the color compensation methods provided by the embodiments of the present disclosure.

It should be noted that the division of each module is only a logical division, and all or part of the actual implementation may be integrated into one physical entity or may be physically separated. And these modules can all be implemented in the form of software invoked by a processing element, or can be implemented in the form of hardware, and part of the modules can be realized in the form of calling software by the processing element, and part of the modules can be realized in the form of hardware. For example, the determining module may be a processing element separately set up, or may be integrated into a chip of the apparatus, or may be stored in a memory of the apparatus in the form of program code, and a processing element of the apparatus calls and executes the function of the determining module. The other modules are implemented similarly. In addition, all or part of the modules can be integrated together or can be realized. The processing element described herein may be an integrated circuit having signal processing capabilities. In implementation, each step of the above method or each module above may be implemented by an integrated logic circuit of hardware in a processor element or an instruction in the form of software.

For example, the various modules, units, sub-units, or sub-modules may be one or more integrated circuits configured to implement the above methods, such as: one or more Application Specific Integrated Circuits (ASICs), one or more microprocessors (DSPs), or one or more Field Programmable Gate Arrays (FPGAs), among others. For another example, when some of the above modules are implemented in the form of a processing element scheduler code, the processing element may be a general-purpose processor, such as a Central Processing Unit (CPU) or other processor that can call the program code. As another example, these modules may be integrated together and implemented in the form of a system-on-a-chip (SOC).

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A color compensation method of a display device, wherein the display device comprises a display panel and a backlight module, the display panel has a plurality of pixels, and the backlight module comprises a plurality of light-emitting elements, and the method comprising:
obtaining operational information for each of the light-emitting elements;
retrieving a light profile associated with the operational information, wherein the light profile comprises color distribution information corresponding to the respective light-emitting element, and the color distribution information is represented by a plurality of color channels;
determining a resultant backlight color value for each pixel based on light intensity distributions of the light-emitting elements within each of the color channels derived from the light profile; and
adjusting a pixel value of at least one of the plurality of pixels based on the resultant backlight color value corresponding to said pixel.

2. The method of claim 1, wherein the operational information comprises at least one of: a driving current, a temperature, a usage time of the respective light-emitting elements, and a distance from a center of each of the light-emitting elements.

3. The method of claim 1, wherein the adjusting of the pixel value based on the resultant backlight color value further comprises:
transforming the resultant backlight color value into local gamut information corresponding to each pixel; and
compensating pixel values of an input image according to the local gamut information.

4. The method of claim 3, wherein the compensating of the pixel values of the input image according to the local gamut information further comprises:
performing a gamut mapping to map the pixel values of the input image to a target color gamut determined by the local gamut information.

5. The method of claim 1, wherein the resultant backlight color value comprises a summed intensity of each color channel at a location corresponding to each pixel.

6. The method of claim 1, wherein the color distribution information comprises values associated with at least one color channel in a color representation space.

7. The method of claim 1, wherein the light profile further comprises at least one of: spectral distribution information, spatial luminance distribution information, spatial energy distribution information, or a spatial profile describing intensity as a function of distance from the respective light-emitting element.

8. The method of claim 1, wherein the light-emitting element comprises a monochromatic light-emitting diode (LED) or a multi-color LED module.

9. A display device, comprising a display panel and a backlight module, wherein the display device comprises a display panel and a backlight module, the display panel has a plurality of pixels, and the backlight module comprises a plurality of light-emitting elements, wherein the display device further comprises:
a memory; and
at least one processor coupled to the memory, wherein the at least one processor performs operations comprising:
obtaining operational information for each of the light-emitting elements;
retrieving a light profile associated with the operational information, wherein the light profile comprises color distribution information corresponding to the respective light-emitting element, and the color distribution information is represented by a plurality of color channels;
determining a resultant backlight color value for each pixel based on light intensity distributions of the light-emitting elements within each of the color channels derived from the light profile; and
adjusting a pixel value of at least one of the plurality of pixels based on the resultant backlight color value corresponding to said pixel.

10. The display device of claim 9, wherein the operational information comprises at least one of: a driving current, a temperature, a usage time of the respective light-emitting elements, and a distance from a center of each of the light-emitting elements.

11. The display device of claim 9, wherein, in adjusting the pixel value based on the resultant backlight color value, the processor is further configured to perform operations comprising:
transforming the resultant backlight color value into local gamut information corresponding to each pixel; and
compensating pixel values of an input image according to the local gamut information.

12. The display device of claim 11, wherein, in compensating the pixel values of the input image according to the local gamut information, the processor is further configured to perform operations comprising:
performing a gamut mapping to map the pixel values of the input image to a target color gamut determined by the local gamut information.

13. The display device of claim 9, wherein the resultant backlight color value comprises a summed intensity of each color channel at a location corresponding to each pixel.

14. The display device of claim 9, wherein the color distribution information comprises values associated with at least one color channel in a color representation space.

15. The display device of claim 9, wherein the light profile further comprises at least one of: spectral distribution information, spatial luminance distribution information, spatial energy distribution information, or a spatial profile describing intensity as a function of distance from the respective light-emitting element.

16. The display device of claim 9, wherein the light-emitting element comprises a monochromatic light-emitting diode (LED) or a multi-color LED module.
